(19) United States
(12) Patent Application Publication
(10) Pub. No.: US 2004/0029257 A1
(43) Pub. Date: Feb. 12, 2004

(54) Process for purifying energetic gases such as biogas and natural gas

(75) Inventors: Frederic Dutil, Quebec (CA); Claude Villeneuve, Quebec (CA)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: CO2 Solution, Val Belair (CA)

(21) Appl. No.: 10/408,663

(22) Filed: Apr. 3, 2003

Related U.S. Application Data
(63) Continuation-in-part of application No. 10/353,171, filed on Jan. 28, 2003.

(30) Foreign Application Priority Data
Jan. 28, 2002 (CA) 2,369,331

(51) Int. Cl. C12S 5/00

(52) U.S. Cl. 435/266

(57) ABSTRACT

A process is disclosed for purifying a gas stream containing a contaminant gas and an energetic gas. The process comprises the steps of: a) providing a bioreactor comprising:-a reaction chamber containing a solvent and a biocatalyst capable of catalyzing a transformation reaction of said contaminant gas dissolved in the solvent into ions. The process further comprises the step of b) extracting the contaminant gas from the gas stream, which extraction comprises feeding the gas stream in the reaction chamber and thereby allowing the contaminant gas to dissolve and transform into ions, yielding said energetic gas free of said contaminant gas and leaving a spent solvent containing said ions in solution. Then, in step c) the energetic gas and the spent solvent obtained in step b) are separately released from the reaction chamber. The process further comprises the steps of d) removing the ions from the spent solvent to recycle the solvent; and e) feeding the recycled solvent of step d) in the reaction chamber. This process can advantageously be used to purify biogas and natural gas which contain methane as the energetic gas and carbon dioxide as the contaminant gas.

### CROSS-REFERENCE TO RELATED APPLICATIONS

The present application is a continuation-in-part of U.S. application Ser. No. 10/353,171, filed Jan. 28, 2003 and claims priority therefrom under 35 USC §120 and moreover claims priority under 35 USC §119 to Canadian Application Serial No. 2,369,331, filed Jan. 28, 2002.

### FIELD OF THE INVENTION

This invention concerns in general the field of processes and apparatuses for the separation of a gaseous compound from a mixture of gaseous compounds. The process is based on the use of biochemical catalysts in the accelerated chemical transformation of specific gaseous compounds found in a mixture of gases. More specifically, it concerns the purification of energetic gases such as biogas and natural gas. Even more specifically, the invention concerns the purification of methane-containing energetic gases by removing therefrom the carbon dioxide.

### BACKGROUND OF THE INVENTION

Substantial reserves of low concentration gaseous methane, that is, between 40 and 80% (v/v) exist. Impurities, i.e. the other compounds, as for example CO₂, might be extracted from the gas in order to obtain natural gas containing over 95% of methane. This natural gas can be used as a source of energy to heat, to make electricity, or it can be used in the composition of more complex chemical products, etc. However, the extraction of these impurities from the valuable energetic gas by way of conventional techniques is neither always profitable nor efficient. On the other hand, the gas mixture contains greenhouse gases and, if released in the atmosphere, will contribute to the earth's global warming.

Various technologies for the separation of CO₂ and methane have been developed. Conventional technology in the natural gas industry uses an amine in solution that has the characteristic of absorbing the CO₂ (U.S. Pat. No. 6,156,096; CA1078300; CA2200130; CA950364; EP180670; GB848528; JP 08-252430). A packed column or aspersion column is usually used to increase contact between the liquid and gas phases. This physico-chemical method is generally suitable for large volumes of gas and, is less efficient in the presence of oxygen. The oxygen is present in variable concentrations in biogases and gases produced during the extraction of coal. A glycol derivative that functions under high pressures (up to 300 psi) is also used as an adsorbent. This, however, tends to elevate operation costs. The recuperation of the hydrocarbons composing the said gas is then obtained by cryogenic and distillation procedures that have the disadvantage of expending a lot of energy. A variant of this physico-chemical conventional adsorption process consists of continuously flushing the gas inside hollow and porous fibres. The adsorbent in solution can be found outside of this fibre pattern.

The separation of gases can also be carried out using a porous polymeric membrane acting as a filter (U.S. Pat. No. 4,681,605; U4681612; U.S. Pat. No. 6,128,919; CA2294531; JP08-252430). This membrane functions under a pressure differential and is composed of pores having dimensions selective to the gases present. This method provides for a certain separation but a pure gas is not obtained. Moreover, the temperature of the treated gas must be lower than 200° C. This technique as well as the physico-chemical approach using an adsorbent is generally chosen when a high pressure (>300 psi) gas mixture is available.

Another gas separation process is referred to as PSA (Pressure Swing Adsorption). This technology is based on the selective adsorption of certain gases on a solid matrix (U.S. Pat. No. 5,938,819; FR2758740; GB1120483; CN1 227255; JP57-130527; JP11-050069). Raising the pressure heightens the selectivity of adsorption. When the pressure is reduced, the tendency to adsorb a gas is lowered. These phenomena, exploited in cycles of pressurization/depressurization, allow the selective adsorption and desorption (regeneration) of a gas contained in a mixture of gases. The solid used has a high specific surface. The most frequently used solids include: activated carbon, silica gel, and zeolites, which can be very costly. Also high operation costs must be added since the pressures (˜1000 psi) and operating temperature (˜700° C.) of the PSA process, which depend on the adsorbent used, are very high. A variant to this process is the VSA (Vacuum Swing Adsorption). This process adsorbs at ambient pressure but regenerates the adsorbent with a negative pressure. The PSA and VSA processes are generally used when the pressure of the mixture of gases to be treated is low (<300 psi). The presence of water vapour in the gas or a high gaseous temperature decreases the efficiency of the technology.

Also known in the prior art, there is a process where a mixture of gases containing a high concentration of CO₂ is liquefied by increasing the pressure and reducing the temperature. Examples of such process are disclosed in CA1190470; CA2361809; and EP0207277. This process is essentially a distillation of the mixture of gases and requires an important quantity of energy. Furthermore, the mixture of gases must have been previously dried in order to avoid the formation of ice in the equipment.

A major hurdle to the massive use of low concentrated biogases or gaseous hydrocarbons as an energy source is the high cost of extracting gas contaminants. Furthermore, a system, which works without concentration, temperature or humidity limits, would increase the acceptance of this large-scale process. One also needs a fast contaminant-specific purification process that does not use compounds toxic for the environment.

Another alternative is the use of an enzyme to accelerate the solubilization of CO₂ in water. Carbonic anhydrase is easily available and has a strong tendency to react. The enzyme has, for these reasons, already been used in its immobilized form for the purification by affinity column, for the transportation through membranes and recently, for the reduction of carbon dioxide emissions in enzymatic reactors. Related to this, Trachtenberg (U.S. Pat. No. 6,143,556) describes a system for the gas phase treatment of gas effluents with an enzyme, i.e. carbonic anhydrase. EP0991462; WO9855210; CA2291785 in the name of the applicant also proposes a process for the use of the enzyme in the treatment of a CO₂-containing gas. Although these processes have proved to be effective to remove the CO₂ contained in a mixture of gases, they are not adapted or suitable for the purification of energetic gases such as biogas or natural gas on a large scale.

Although there has been a lot of development made in the field of gas separation or gas purification, there is still a need for a process that would allow a large-scale production of energetic gases such as methane contained in the biogas and the natural gas at a relatively low cost.

### SUMMARY OF THE INVENTION

An object of the present invention is to provide a process that satisfies the above-mentioned need and that overcomes several of the above-mentioned drawbacks concerning the prior process for the purification of energetic gases such as biogas and natural gas.

An auxiliary object, which is obtained with a preferred embodiment of the invention, is to reduce greenhouse gases.

In accordance with the present invention, that object is achieved with a process for purifying a gas stream containing a contaminant gas and an energetic gas. The process comprises the steps of:

a) providing a bioreactor comprising:

a reaction chamber containing a solvent and a biocatalyst capable of catalyzing a transformation reaction of the contaminant gas dissolved in the solvent into ions;

b) extracting the contaminant gas from the gas stream, comprising the steps of:

feeding the gas stream in the reaction chamber and thereby allowing the contaminant gas to dissolve and transform into ions, yielding the energetic gas free of the contaminant gas and leaving a spent solvent containing the ions in solution;

c) separately releasing the energetic gas and the spent solvent obtained in step b) from the reaction chamber;

d) removing the ions from the spent solvent to recycle the solvent; and

e) feeding the recycled solvent of step d) in the reaction chamber.

In step a) above, the solvent is preferably exempt of the contaminant gas and saturated with the energetic gas to be cleaned.

As can be appreciated, and thanks to the fact that the spent solvent is regenerated and recycled back into the reaction chamber, the process of the invention makes possible the production on a large scale of energetic gases. Indeed, since the spent solvent, which is essential to dissolve the gaseous contaminant, is recycled back into the process, the process is operable without the need of an outside source of solvent. Without the recycling of the spent solvent, enormous quantity of fresh solvent from an outside source would have to be supplied to the bioreactor to enable the purification of energetic gases on a large scale.

Also, since a certain amount of the energetic gas might as well have dissolved in the solvent, the spent solvent, which is recycled back into the reaction chamber, is saturated of energetic gas.

Another advantage of the invention in comparison to other available technologies is that the mixture of gas requires no pretreatment (dehydration, preliminary extraction) before arrival in the transfer system.

Still another advantage of this invention is that everything takes place at ambient temperature and pressure conditions. The operating costs are therefore decreased with regard to other technologies.

In accordance with a preferred aspect, the process is used to clean a biogas or a natural gas, which contain methane and carbon dioxide. In that particular case, the energetic gas is methane, the contaminant gas is carbon dioxide, the biocatalyst is carbonic anhydrase or an analog thereof and the solvent contains water.

The process can also be used to purify the other gases found in the natural gas, namely ethane, propane, butane, iso-butane, pentane, iso-pentane, hexane, nitrogen, hydrogen, oxygen, argon, helium, and neon.

Also preferably, step e) of removing the ions from the spent solvent is performed by means of an ion exchange resin and the process further comprises a step of regenerating the ion exchange resin.

The present invention also concerns a process for purifying a gas stream containing methane as an energetic gas and carbon dioxide as a contaminant gas, the process comprising the steps of:

a) providing a bioreactor comprising:

a reaction chamber filled with an aqueous solvent containing a biocatalyst capable of catalyzing the chemical conversion of dissolved carbon dioxide into an aqueous solution;

b) extracting the carbon dioxide from the gas stream, comprising the steps of:

feeding the gas stream in the reaction chamber and thereby allowing the carbon dioxide to dissolve and transform into hydrogen ions and bicarbonate ions, yielding the energetic gas free of carbon dioxide and leaving a spent solvent containing the hydrogen ions and bicarbonate ions in solution;

c) releasing the energetic gas and the spent solvent obtained in step b) from the reaction chamber;

d) removing the hydrogen ions and bicarbonate ions from the spent solvent to recycle the solvent; and

e) feeding the recycled solvent of step d) in the reaction chamber.

The bicarbonate ions are then preferably precipitated as a solid or re-transformed into pure CO₂. The application of this invention can allow the recuperation of large quantities of potentially energetic gases while avoiding the emission of greenhouse gases and allowing geological sequestration of CO₂.

### BRIEF DESCRIPTION OF THE DRAWINGS

Other objects and advantages of the invention will become apparent upon reading the detailed description and upon referring to the drawings in which:

FIG. 1 is a schematic process diagram of a first preferred embodiment of the process according to the present invention.

FIG. 2 is a schematic process diagram of a second preferred embodiment of the process according to the present invention

While the invention will be described in conjunction with example embodiments, it will be understood that it is not intended to limit the scope of the invention to such embodiments. On the contrary, it is intended to cover all alternatives, modifications and equivalents as may be included as defined by the appended claims.

### DESCRIPTION OF PREFERRED EMBODIMENTS

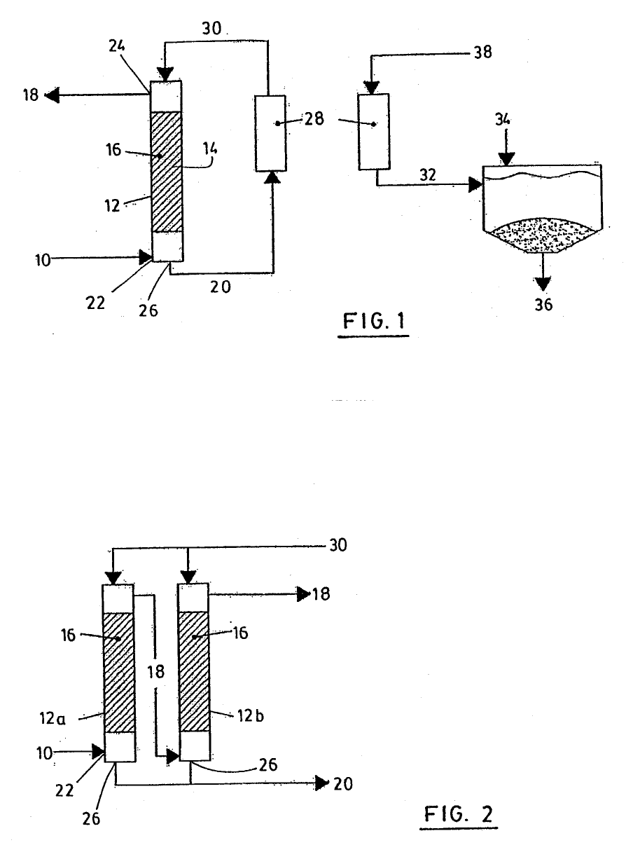

Referring to FIG. 1, and broadly described, a process according to the invention is for purifying a gas stream (10) containing a contaminant gas, such as for example carbon dioxide, and an energetic gas, biogas or natural gas. The process is performed in a bioreactor (12) comprising a reaction chamber (14) filled or flushed with a solvent. The reaction chamber (14) contains a biocatalyst (16) capable of catalyzing a transformation reaction of the contaminant gas dissolved in the solvent into ions. In the case where carbon dioxide has to be extracted from the gas stream (10), the biocatalyst used is preferably the enzyme carbonic anhydrase or an analog thereof and the solvent contains water.

Since the bioreactor (12) is used in part for dissolving the contaminant gas, it might also be referred to hereinbelow as the dissolution module or the gas-liquid transfer system.

The bioreactor (12) represented in FIG. 1 is in the form of a packed tower, such as the one described in the above-mentioned prior applications CA 2291785 and WO 9855210 in the name of the applicant. It is however worth mentioning that the invention is not limited to this particular type of bioreactor and that other bioreactors already known in the prior art may advantageously be used.

This system allows for the transformation of gaseous CO₂ into bicarbonate and hydrogen ions. The transformation of CO₂ into bicarbonate ions, usually a slow naturally occurring process, is catalyzed by an enzyme, which is in an immobilized or free state inside the reaction chamber (14) of the bioreactor (12). The equilibrium reaction must undergo an intermediate hydration that slows the transformation of CO₂ into bicarbonate ions. The enzymatic system catalyses this hydration of dissolved carbon dioxide. The following equations describe the relevant processes:

without enzyme: dissolved CO₂⇄H₂CO₃⇄H⁺+HCO₃⁻ (IV)

with enzyme: dissolved CO₂⇄H⁺+HCO₃⁻ (V)

The process thus comprises the steps a) of providing such a bioreactor (12) and then b) extracting the CO₂ contaminant gas from the gas stream (10). In order to extract the contaminant gas, the gas stream (10) is fed in the reaction chamber (14) via an appropriate gas inlet (22) thereby allowing the contaminant gas to dissolve and transform into hydrogen and bicarbonate ions within the reaction chamber (14), yielding the methane energetic gas (18) free of CO₂ contaminant gas and leaving a spent solvent (20) containing the ions in solution, and a certain amount of dissolved energetic gas in an equilibrium concentration.

The gaseous phase of the energetic gas (18) and the spent solvent (20) are released from the reaction chamber (14) via a respective gas outlet (24) and a liquid outlet (26). Then the ions are removed from the spent solvent (20) to recycle the same within the reaction chamber (14). More specifically, the spent solvent (20) passes through an ion exchange resin (28) where contaminants transformed into ions in solution are removed. The recycled solvent (30), which now only contains the energetic gas in solution in an equilibrium concentration, is fed back into the reaction chamber (14) ready to extract contaminants. When the resin (28) no longer contains active sites capable of adsorbing ions, it is regenerated with a chemical regenerator (38). The obtained solution (32) will be concentrated in ions. The ions can, by the addition of additional ions (34), be precipitated as a solid (36).

Referring to FIG. 2 a second preferred version of the process according to the invention is represented. This embodiment provides a method for obtaining a gas of superior purity. This method can also be used for extracting several different contaminants. FIG. 2 shows two dissolving bioreactors (12a, 12b) organized in series where the exit of purified gas (11) from the first bioreactor (12a) returns to the second bioreactor, which contains the same enzyme as the first or a different enzyme (16). The rest of the treatment sequence follows the same steps as FIG. 1.

As can be appreciated, the invention is directed to the use of enzymes, so as to extract one or several compounds from a potentially energetic gaseous mixture. The gas or gases to be extracted are previously dissolved in a liquid phase called a solvent to be then transformed by one or several ionized enzymes. This enzyme can be immobilized on a support or in suspension in the solution. This way, contaminants can be removed from them to become a concentrated or purified gas mixture. One or several separated gases transformed into aqueous ions can be converted into inert solids or reconverted into pure gas.

Every gaseous compound has a solubility equilibrium with a given solvent and the maximum concentration of the dissolved compound is dependent on temperature and partial pressure conditions of the gas. The transfer of the compound between the two phases is interrupted when this maximum concentration is reached. Table 1 lists a number of compounds originating from landfill sites, which can be found in a biogas.

It is worth noting that, if one wants to remove the CO₂ from this gas mixture and to transfer it to a liquid phase, that the water solubility of CO₂ is 24 times that of methane. Therefore, the CO₂ will preferentially be adsorbed in water as opposed to methane. If the solubility equilibrium is reached for methane but not for the carbon dioxide, only the gas phase CO₂ will continue to diffuse in the liquid phase. Since a physico-chemical mechanism allows for the removal of CO₂ as it is formed, the equilibrium is never achieved and the gaseous CO₂ continues to be dissolved in the aqueous phase.

In the process according to the invention, the gas mixture (10) enters into contact with a solvent inside conventional gas/liquid transfer systems (12) such as a packed column, aspersion tower, triphasic column or any other system (without limiting itself to it). The liquid phase, that is to say the solvent, preferably contains the to-be-purified compound in solution in an equilibrium concentration, thus saturated, with the gas phase. Furthermore, this solvent is free of the to-be-extracted compound. An enzyme (16) specially selected to catalyze the transformation of the to-be-extracted compound is found inside the gas/liquid transfer system. This transformation generates ions in solution.

The solvent can then flush through the ion exchange resin (28) where only selected ionic compounds are trapped. The compounds that are not ionized in solution, i.e. those that have strong covalent bonds, stay in solution. A regeneration of the resin (28) is necessary once all of the resin's active sites are occupied. A second solution strongly charged in ions is then obtained.

The ions in solution can be precipitated as an inert solid (34) by the addition of cations or additional anions. The produced ions can also be re-transformed as a gas by means of temperature and/or pressure change. In both cases, the solid and the gas generated are preferred.

One of the advantages of the invention by comparison to other available technologies, is that the mixture of gas requires no pre-treatment (dehydration, preliminary extraction) before its arrival in the transfer system. A cooling system may be necessary for cases where the gas temperature increases that of the liquid to temperatures superior to what the enzyme can tolerate. Using an enzyme that tolerates high temperature, pH and pressure can be also envisaged.

Another advantage of this invention is that the process can take place at normal temperature and pressure conditions. The operating costs are therefore decreased with regard to other technologies.

If several gases must be extracted from the initial mixture, several types of enzymes may be present in the dissolving module. It could also be advantageous to use several modules in series which will have for an individual task the extraction of a single compound at a time.

A first flushing of the gas mixture will not necessarily produce a gas free of contaminants. However, to increase the purity of the treated gas, the user can reflush the gas in the dissolving module (12) until the required concentration is obtained.

TABLE 1
Solubility in water of certain gases contained in biogas
found in landfills.

| Pure Gas | Solubility (Mol ×/total Mol)* |
|---|---|
| Éthane (C₂H₄) | 3.40 × 10⁻⁵ |
| Methane (CH₄) | 2.55 × 10⁻⁵ |
| Oxygen (O₂) | 2.29 × 10⁻⁵ |
| Hydrogen (H₂) | 1.41 × 10⁻⁵ |
| Nitrogen (N₂) | 1.18 × 10⁻⁵ |
| Hexane (C₆H₁₄) | 1.1 × 10⁻⁵ |
| Propane (C₃H₈) | 2.73 × 10⁻⁵ |
| Isobutane (C₄H₁₀) | 1.66 × 10⁻⁵ |
| Carbon dioxide (CO₂) | 6.15 × 10⁻⁴ |
| Hydrogen sulphide (H₂S) | 1.85 × 10⁻³ |

*normal pressure and temperature

### EXAMPLES

The biogas found in landfill sites is formed from the anaerobic decomposition of buried biodegradable matter. This gas mainly consists of nitrogen (N₂), carbon dioxide (CO₂) and methane (CH₄). Volatile hydrocarbons as well as volatile sulphured compounds are found in weaker concentrations. The release into the atmosphere of CO₂ and CH₄, both recognised as principal greenhouse gases, aggravates the global warming problem.

In a sustainable development context, the gas resulting from the biomethanation of organic matter is a renewable source of energy in the same way as the energy exploitation of the biomass. The capture of biogases and their burning can sometimes provide the recovery of energy which can be used to produce, among others, some electricity or vapour. To achieve this, the methane concentration of the biogas must be sufficiently high, and one must be using equipment adapted to this type of gas mixture. Furthermore, the use of a gas with a low concentration of methane may require the use of a catalyst or an adequate dose of oxygen and favours a high production of NOx due to a high flame temperature. In most cases, the heat or energy generators cannot work directly with biogases and a preliminary separation of the CO₂ is necessary.

For an application of this technology in the treatment of the biogas escaping from a landfill site, the biogas (10) is put in contact with a solvent containing some methane in equilibrium balance with the gas phase. The enzyme (16) used in the gases dissolving module (12) is the carbonic anhydrase, which has the capacity to catalyze the transformation of aqueous CO₂ in ionic bicarbonate.

The bicarbonate is removed from the solution by adsorption on an anionic resin and, subsequently, concentrated in resin's regeneration solution. The bicarbonate can be coupled with a cation such as calcium (34) to form solid calcium carbonate (36). This inert precipitate can be used at the landfill site as a recovering material.

The purified methane, found in concentrations superior to 95%, can be used as fuel. No greenhouse gases are therefore emitted into the atmosphere.

Purification of the Natural Gas

The natural gas must be purified of its water vapour, carbon dioxide and other contaminants content before its liquefaction. This raw natural gas may come from the extraction of coal or petroleum. Once the gas is liquefied, it can be transported by pipeline. If the purification steps are too expensive and result in an unprofitable operation, the gas will be burned, thereby producing greenhouse gases and sacrificing a potential source of energy.

The process described in the present invention is used to extract the CO₂ and other contaminants contained in a mixture of natural gas. The only step necessary before the liquefaction of the gas is a final dehydration. The CO₂ so separated is preferably combined with cations to form an insoluble precipitate. This precipitate can be exploited on the market or still accumulated in convenient areas such as a pit, and hence, establish an effective, secure and non-polluting form of geologic sequestration of CO₂.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

What is claimed is:

1. A process for purifying a gas stream containing a contaminant gas and an energetic gas, the process comprising the steps of:
a) providing a bioreactor comprising:
a reaction chamber containing a solvent and a biocatalyst capable of catalyzing a transformation reaction of said contaminant gas dissolved in the solvent into ions;
b) extracting the contaminant gas from the gas stream, comprising the steps of:
feeding said gas stream in the reaction chamber and thereby allowing the contaminant gas to dissolve and transform into ions, yielding said energetic gas free of said contaminant gas and leaving a spent solvent containing said ions in solution;
c) separately releasing the energetic gas and the spent solvent obtained in step b) from the reaction chamber;
d) removing said ions from the spent solvent to recycle the solvent; and
e) feeding the recycled solvent of step d) in the reaction chamber.

2. A process according to claim 1, wherein in step a) the solvent is exempt of said contaminant gas.

3. A process according to claim 2, wherein in step a) the solvent is saturated with said energetic gas to be clean.

4. A process according to claim 1, wherein the energetic gas is selected from the group consisting of methane, ethane, propane, butane, iso-butane, pentane, iso-pentane, hexane, nitrogen, hydrogen, oxygen, argon, helium, and neon.

5. A process according to claim 1, wherein the energetic gas is methane.

6. A process according to claim 5, wherein the gas stream is selected from the group consisting of biogas and natural gas.

7. A process according to claim 6, wherein the contaminant gas is carbon dioxide, the biocatalyst is carbonic anhydrase or an analog thereof and the solvent contains water.

8. A process according to claim 1, wherein step e) of removing the ions from the spent solvent is performed by means of an ion exchange resin.

9. A process according to claim 8, comprising a step of regenerating the ion exchange resin.

10. A process according to claim 1, wherein the biocatalyst is in suspension in the solvent, or immobilized on or entrapped in a support.

11. A process according to claim 1, comprising a step of adjusting the temperature of the gas stream to avoid deactivating the biocatalyst.

12. A process for purifying a gas stream containing methane as an energetic gas and carbon dioxide, the process comprising the steps of:
a) providing a bioreactor comprising:
a reaction chamber containing an aqueous solvent and a biocatalyst capable of catalyzing the chemical conversion of dissolved carbon dioxide into an aqueous solution containing;
b) extracting the carbon dioxide from the gas stream, comprising the steps of:
feeding said gas stream in the reaction chamber and thereby allowing the carbon dioxide to dissolve and transform into hydrogen ions and bicarbonate ions, yielding said energetic gas free of carbon dioxide and leaving a spent solvent containing said hydrogen ions and bicarbonate ions in solution;
c) separately releasing the energetic gas and the spent solvent obtained in step b) from the reaction chamber;
d) removing said hydrogen ions and bicarbonate ions from the spent solvent to recycle the solvent; and
e) feeding the recycled solvent of step d) in the reaction chamber.
